(19) United States
(12) Patent Application Publication
(10) Pub. No.: US 2008/0195753 A1
(43) Pub. Date: Aug. 14, 2008

(54) RELAY APPARATUS, RECORDING MEDIUM CONTAINING RELAY PROGRAM, AND COMMUNICATION SYSTEM

(75) Inventor: Yuusuke Shimada, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/026,218

(22) Filed: Feb. 5, 2008

(30) Foreign Application Priority Data
Feb. 14, 2007 (JP) 2007-033247

(51) Int. Cl. G06F 15/16

(52) U.S. Cl. 709/238

(57) ABSTRACT

A relay apparatus that transfers packets each including identification information specifying connection between a first apparatus and a second apparatus, a destination address, and a source address performs: receiving, from the first apparatus, a first packet in which the identification information includes encryption information obtained by encrypting an address of the first apparatus; transmitting, to the second apparatus, a second packet in which the source address of the first packet is converted into an address of the relay apparatus; receiving, from the second apparatus, a third packet in which the destination address and source address of the second packet are switched; and transmitting, to the first apparatus, a fourth packet in which the destination address is converted on the basis of the address of the first apparatus, which is obtained by decrypting encryption information included in the identification information of the third packet.

### BACKGROUND

The present invention relates to a technology in which a relay apparatus, located among a plurality of apparatuses for transmitting and receiving call processing packets using an Internet protocol (IP), for transmitting a call processing packet received from one apparatus to a different apparatus, and more particularly, to relay apparatus that can transmit a call processing packet received from one apparatus to a different apparatus in any state.

### SUMMARY

According to an aspect of an embodiment of the present invention, a relay apparatus that transfers packets each including identification information specifying connection between a first apparatus and a second apparatus, a destination address, and a source address performs: receiving, from the first apparatus, a first packet in which the identification information includes encryption information obtained by encrypting an address of the first apparatus, and which has an address of the second apparatus as the destination address, and the address of the first apparatus as the source address; transmitting, to the second apparatus, a second packet in which the source address of the first packet is converted into an address of the relay apparatus; receiving, from the second apparatus, a third packet in which the destination address and source address of the second packet are switched; and transmitting, to the first apparatus, a fourth packet in which the destination address is converted on the basis of the address of the first apparatus, which is obtained by decrypting encryption information included in the identification information of the third packet.

### BRIEF DESCRIPTION OF THE DRAWINGS

FIG. 1 is a block diagram showing an overview of the present invention;

FIG. 2 is a block diagram showing a hardware configuration of a relay apparatus;

FIG. 3 is an illustration showing the configuration of a load-distribution definition table;

FIG. 4 is an illustration showing the configuration of a server-information conversion table;

FIG. 5 is an illustration showing a distributed server correspondence table;

FIG. 6 is a flowchart showing relay processing in an embodiment of the present invention;

FIG. 7 is an illustration showing the structure of a packet in the embodiment;

FIG. 8 is an illustration showing an example of a request packet in the embodiment; and

FIG. 9 is an illustration showing an example of a response packet in the embodiment.

### DESCRIPTION OF THE PREFERRED EMBODIMENTS

An embodiment of the present invention is described below with reference to the accompanying drawings.

### 1. Block Diagram Showing Overview of the Present Invention

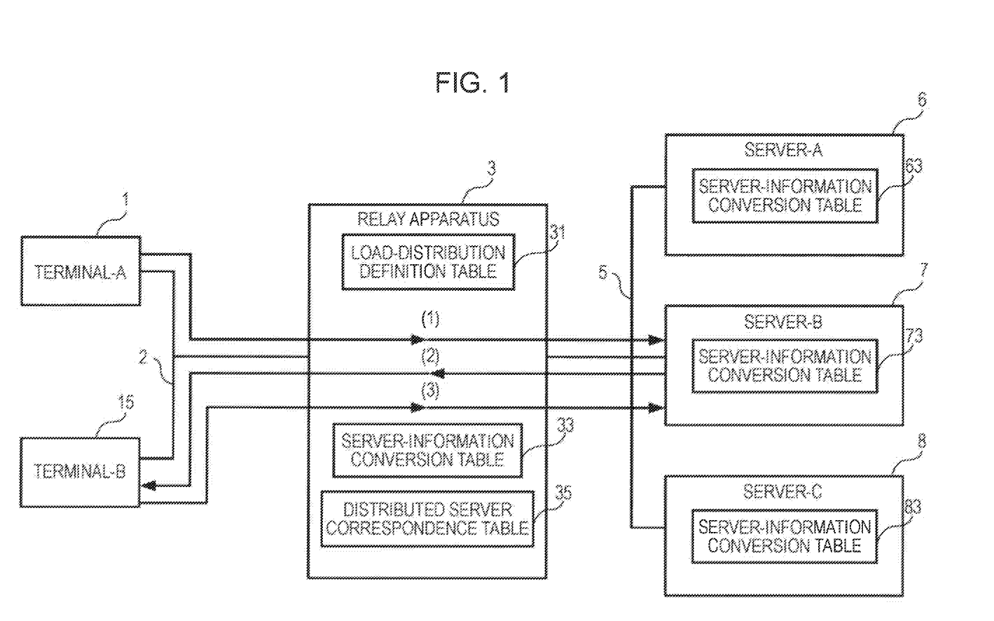

FIG. 1 is a block diagram showing an overview of the present invention. An information processing system for realizing IP telephone according to the present invention includes a terminal-A 1, a terminal-B 15, a network-C 2, a relay apparatus 3, a network-D 5, a server-A 6, a sever-R 7, and a server-C 8, The terminal-A 1 and the terminal-B 15 comply with the SIP (session initiation protocol). The SIP may be referred to as “call control information” for controlling audio communication. Here, the terminal-A 1 is a calling party, and the terminal-B 15 is a called party. The terminal-A 1 or the terminal-B 15 may be referred to as a “second apparatus”. The network-C 2 is a communication network for connecting one of the terminal-A 1 and the terminal-B 15, and the relay apparatus 3. The relay apparatus 3 receives a packet to be conveyed among one of the terminal-A 1 and the terminal-B 15, and one of the server-A 6 and the server-B 7, and the server-C 8, and sends the packet to a different apparatus. The relay apparatus 3 also has a load distribution function of performing load distribution so that loads on the server-A 6, the sever-B 7, and the server-C 8, which process a packet received from the terminal-A 1 as the calling party, are equal. In addition, the relay apparatus 3 has an address conversion function for converting an IP address in order to expose only an address of the relay apparatus 3 to the terminal-B 15 as the called party. The network-D 5 is a communication network for connecting the relay apparatus 3, and one of the server-A 6, the sever-B 7, and the server-C 8. The server-A 6, the server-B 7, and the server-C 8 comply with the SIP. The server-A 6, the sever-B 7, or the server-C 8 may be referred to as a “first apparatus”. The term “IP address” (address) is a number specifying a network-connected apparatus. In addition, communication between one of the terminal-A 1 and the terminal-B 15, and one of the server-A 6, the sever-B 7, and the server-C 8 is necessarily routed through the relay apparatus 3 by using a routing protocol.

Operations of the relay apparatus 3 according to the present invention are briefly described below.

1) The relay apparatus 3 receives a packet from the terminal-A 1 as the calling party. An address used to receive this packet is a virtual IP address exposed by the relay apparatus 3 to the terminal-A 1 as the calling party. This virtual IP address is defined as an IP address representing a distribution destination by the relay apparatus 3. Next, the relay apparatus 3 selects a distributed SIP server by considering communication statuses, response times, etc., of distributed SIP servers. The relay apparatus 3 extracts an IP address of the selected distributed SIP server from a load-distribution definition table 31 defining IP addresses of the distributed SIP servers. The relay apparatus 3 transmits a packet including the extracted IP address as a destination. Here, it is assumed that the server-B 7 is selected as a distribution destination.
(2) The relay apparatus 3 receives a packet from the server-B 7. This packet, includes encryption information obtained by encrypting an address specifying the server-B 7. The encryption converts a character string representing the address into another character string by using a server-information conversion table 73 defining a conversion method determined beforehand with the relay apparatus 3. Next, the relay apparatus 3 transmits, to the terminal-B 15 as the called party, a packet in which a transmission source of the received packet is rewritten by a virtual IP address of the relay apparatus 3.
(3) The relay apparatus 3 receives the packet including the encryption information from the terminal-B 15, Next, the relay apparatus 3 decrypts the encryption information. In the decryption, the character string converted in the operation (2) is restored by using a server-information conversion table 33 having information similar to that of the server-information conversion table 73. The relay apparatus 3 extracts, from a distributed server correspondence table 35, destination information corresponding to the address which specifies the server-B 7 and which is obtained by decryption, The relay apparatus 3 transmits a packet in which the extracted destination information is set.

The above operations (2) and (3) form the present invention. The present invention is fully described below.

### 2. Block Diagram Showing Hardware Configuration of Relay Apparatus

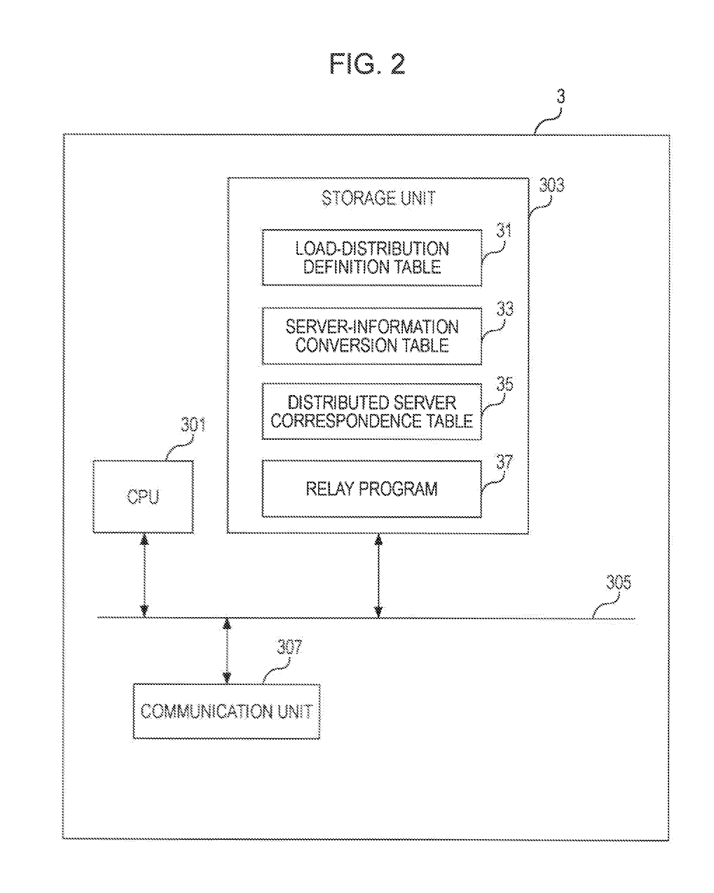

FIG. 2 is a block diagram showing an example of a hardware configuration of the relay apparatus 3. The relay apparatus 3 includes a CPU (central processing unit) 301, a storage unit 303, a communication unit 307, and a bus 305. The CPU 301 performs control of other units and performs various types of calculation. The storage unit 303 includes the load-distribution definition table 31, the server-information conversion table 33, the distributed server correspondence table 35, and a relay program 37. The storage unit 303 also operates as a RAM (random access memory) for executing a program and storing data, a ROM (read-only memory) for storing a program and data, or an external storage device for storing large amounts of programs and data.

The load-distribution definition table 31 includes an IP address of a server that serves as a distribution destination corresponding to the virtual IP address. The server-information conversion table 33 has information for decrypting the encryption information extracted from the packet received from the terminal-B 15. The distributed server correspondence table 35 includes an IP address of a server that is a distribution destination corresponding to the decrypted information. The relay program 37 realizes the operations (1) to (3). The bus 305 exchanges data among the CPU 301, the storage unit 303, and the communication unit 307. The communication unit 307 performs communication between one of the terminal-A 1 and the terminal-B 15, and the relay apparatus 3, and communication between one of the server-A 6, the server-B 7, and the server-C 8, and the relay apparatus 3.

### 2.1. Illustration Showing Configuration of Load-Distribution Definition Table

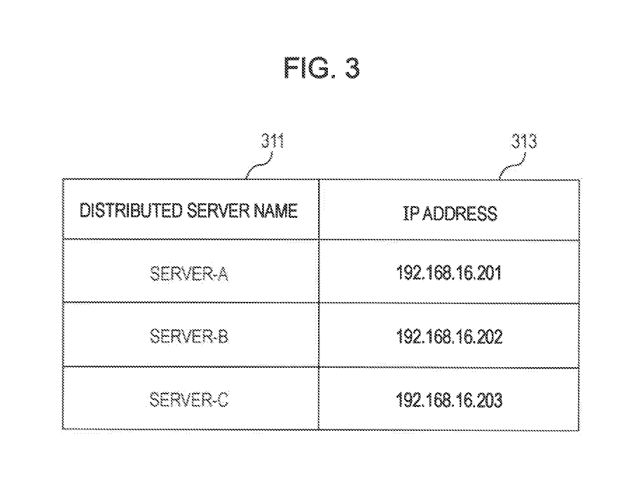

FIG. 3 shows the load-distribution definition table 31, which has information for the relay apparatus 3 to determine an IP address of a server that serves as a distribution destination corresponding to a virtual IP address. Information elements of the load-distribution definition table 31 include distributed server names 311 and IP addresses 313. Each distributed server name 311 is used when the relay apparatus 3 specifies a distribution destination. Each IP address 313 is used as a destination of a packet that is transmitted by the relay apparatus 3 to the distribution destination.

### 2.2. Illustration Showing Configuration of Server-Information Conversion Table

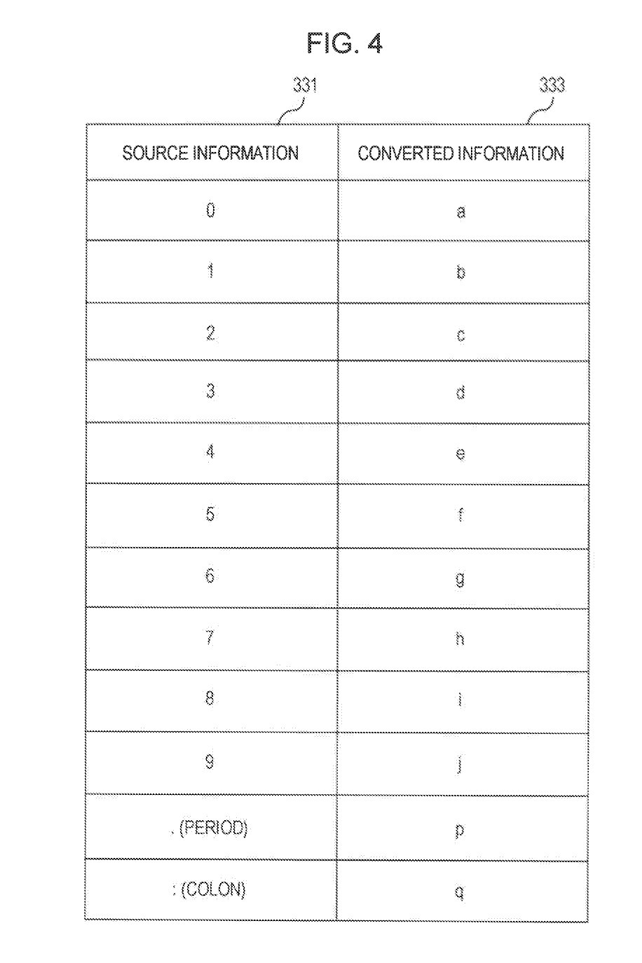

FIG. 4 shows the server-information conversion table 33, which has information for decrypting the encryption information extracted from the packet received from the terminal-B 15 as the called party. Information elements of the server-information conversion table 33 include source information 331 and converted information 333. Pieces of the source information 331 represent unconverted characters. Pieces of the converted information 333 represent converted characters.

### 2.3. Illustration Showing Configuration of Distributed Server Correspondence Table

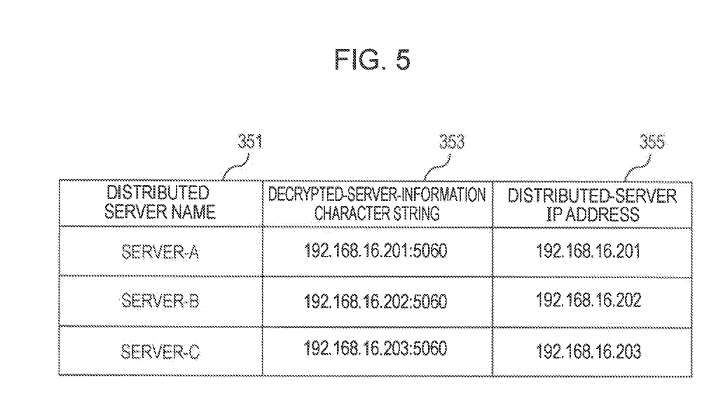

FIG. 5 shows the distributed server correspondence table 35, which includes IP addresses of servers that are distribution destinations corresponding to decrypted encryption information. Information elements of the distributed server correspondence table 35 include distributed server names 351, decrypted-server-information character strings 353, and distributed-server IP addresses 355. Each distributed server name 351 is used when a manager of the relay apparatus 3 confirms a distributed server name. Each decrypted-server-in formation character string 353 is used when the relay apparatus 3 specifies a corresponding distributed-server IP address. Each distributed-server IP address 355 is used as a destination of a packet that is transmitted to a distribution destination by the relay apparatus 3.

### 3. Flowchart of Relay Processing

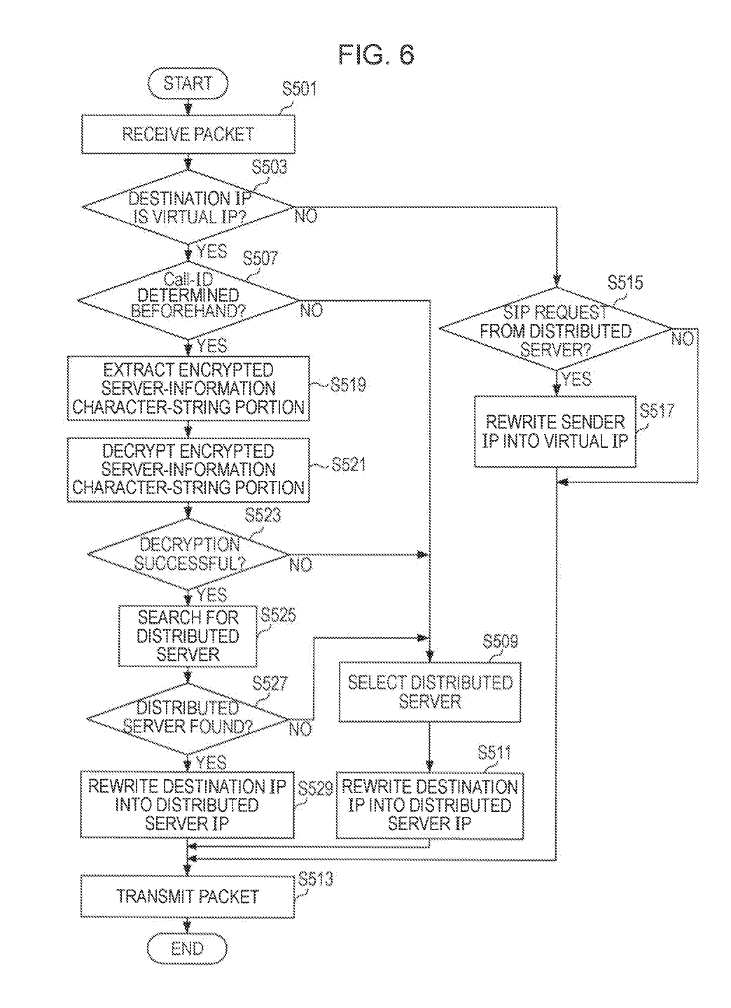

FIG. 6 is a flowchart showing a process of the relay apparatus 3 according to the present invention. The CPU 301 in the relay apparatus 3 realizes the process according to the present invention by controlling the relay program 37. Here, the process is described below in the operation order shown in FIG. 1.

First, a process of the relay apparatus 3 when it performs the operation (1) in FIG. 1 is described.

In step S501, the CPU 301 receives a packet transmitted by the terminal-A 1 as the calling party through the communication unit 307. This packet includes an IP header, a UDP header, a SIP start line, an SIP header, and an SIP message body.

### 3.1. Illustration of Packet Structure

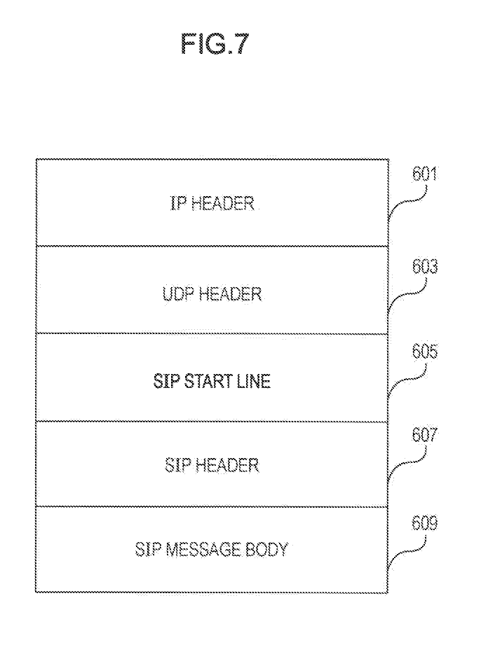

FIG. 7 shows the structure of a packet according to the present invention. An IP header 601 includes a transmission source IP address that is an IP address of a party that transmits the packet, and a destination IP address that is an IP address of another party to which the packet is conveyed. In the case of the operation (1) in FIG. 1, an IP address of the terminal-A 1 is set as the source address, and a virtual IP address, set in the relay apparatus 3, is set as the destination IP address.

A UDP header 603 includes a transmission source port number that is a port number of the party that transmits the packet, and a destination port number that is a port number of the party to which the packet is conveyed. The term “UDP” is an abbreviation of a user datagram protocol. In addition, the term “port number” is an auxiliary address provided below an IP address in order to establish simultaneous connection to a plurality of different parties. In the case of the operation (1) in FIG. 1, a port number of the terminal-A 1 is set as the transmission source port number, and a pert number of the relay apparatus 3 is set as the destination port number.

A SIP start line 605 is used to define A SIP message. A SIP message is divided into two types, a request and a response. The request includes a method name representing a request type. Request types include INVITE (establish a call), BYE (finish a call), and CANCEL (finish establishing processing in the middle of call setting). The response includes a status code representing a response type. Response types include “1xx” (temporary), “2xx” (success), “3xx” (client error) , and “4xx” (server error). In the case of the operation (1) in FIG. 1, a request for establishing a call with the terminal-B 15 is set.

A SIP header 607 is used to define various types of information necessary for processing the SIP message. Header types include a “To header” (transmission destination of request), a “From header” (transmission source of request), and a “Call-ID header” (which is identification information specifying connection between apparatuses and which is used to specify a call). In the case of the operation (1) in FIG. 1, various types of information for the terminal-A 1 to establish a call with the terminal-B 15 are set.

A SIP message body 609 is used to define information based on a format defined by a protocol other than the SIP. This information is an option in SIP message configuration. In the operation (1) in FIG. 1, this information is set according to conditions for the terminal-A 1 to establish a call with the terminal-B 15.

Referring back to FIG. 6, the process of the relay-apparatus 3 when it performs the operation (1) in FIG. 1 is continuously described.

In step S503, the CPU 301 determines whether the received packet is addressed to a virtual IP address. This determination is performed by checking whether the above destination IP address is identical to the above virtual IP address. In the case of the operation (1) in FIG. 1, a virtual IP address is set. Accordingly, the process proceeds to step S507.

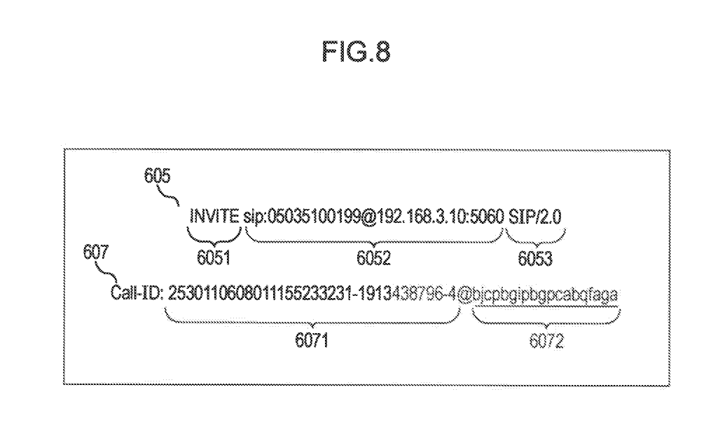

In step S507, the CPU 301 verifies the format of the Call-ID. This verification is performed by determining whether the format of the Call-ID has been determined beforehand with a distributed server. This determination is performed by checking whether the number of characters of a portion 6072 (FIG. 8) succeeding at the mark of the Call-ID header is the sum of the IP address and the port number, and checking whether all character types are the converted characters as the converted information 333 in the server-information conversion table 33. In the case of the operation (1) in FIG. 1, the Call-ID format has not been determined with the distributed server. Accordingly, the process proceeds to step S509.

In step S509, the CPU 301 selects a distributed server for distributing the packet. This selection is performed in order to equalize loads on distributed servers. This selection is performed by considering communication statuses, response times, CPUs, etc., of the distributed servers. Here, it is assumed that the server-B 7 is selected.

In step S511, the CPU 301 sets the IP address of the server-B 7, which is the selected distribution destination, as a destination IP address. The used IP address of the server-B 7 is one IP address 313 in the load-distribution definition table 31 in FIG. 3.

In step S513, the CPU 301 transmits the packet to the sever-B 7 as the distribution destination through the communication unit 307.

Next, the process of the relay apparatus 3 when it performs the operation (2) in FIG. 1 is described below.

In step S501, the CPU 301 receives a packet generated and transmitted by the server-B 7 as the distribution destination through the communication unit 307. In the case of the operation (2) in FIG. 1, the IP address of the server-B 7 is set as the source address, and the IP address of the terminal-B 15 as the called party is set as the destination IP address. In addition, encryption information obtained by encrypting an address capable of identifying the server-B 7 is added to the Call-ID header in the SIP header 607 in this packet. The above address is information of a combination of the IP address and port, number of the server-B 7. This information serves as information related to a number specifying a network-connected apparatus. The encryption is performed by using the server-information conversion table 73 shown in FIG. 1 that defines the conversion method determined beforehand with the relay apparatus 3. The server-information conversion tables 73, 63, and 83 are similar to the server-information conversion table 33 shown in FIG. 4. In specific processing for encryption, the server-B 7 searches the source information 331 for characters representing the above address, and replaces the characters by corresponding converted characters as the converted information 333.

### 3.2. Example of Request Message

FIG. 8 shows examples of the SIP start line 605 and SIP header 607 in the packet used when the relay apparatus 3 performs the operation (2) in FIG. 1. In the case of the operation (2) in FIG. 1, a request message is set in the SIP start line 605. Information elements of the SIP start line 605 include a method name 6051, a request-URI 6052, and a SIP version 6053. The method name 6051 represents a request type. The request-URI 6052 represents a request destination. The term “URI” is an abbreviation of a uniform resource identifier. The term “URI” is a location of an information resource described in a standard form on the Internet.

Although the SIP header 607 includes information elements, the Call-ID header (which is identification information specifying connection between apparatuses and which is used to specify a call) according to the present invention is only described. A portion 6071 preceding the at mark of the Call-ID header is information for identifying a call. For this information, it is recommended to apply the random ID generating rules in RFC1750 in order to set a globally unique value. A portion 6072 succeeding at the mark in the Call-ID header is obtained by encrypting information (address) identifying a distributed server. This information is obtained such that, when a distributed server that serves as a packet transmission source transmits a packet to the terminal-B 15 as the called party, information having both the IP address and port number of the distributed server is encrypted by using the server-information conversion tables 63, 73, and 83. In the case of the operation (2) in FIG. 1, a request message is set in the start line 605.

Referring back to FIG. 6, the process of the relay apparatus 3 when it performs the operation (2) in FIG. 1 is continuously described.

In step S503, the CPU 301 determines whether the received packet is addressed to a virtual IP address. This determination is performed by checking whether the above destination IP address is identical to the above virtual IP address. In the case of the operation (2) in FIG. 1, the process proceeds to step S515 since the virtual IP address is not set.

In step S515, the CPU 301 determines whether the received packet has been sent from the server-B 7 as a distribution destination, and whether the SIP message is a request. The determination of whether the received packet has been sent from the server-B 7 is performed by checking whether a transmission source IP address in the IP header 601 is included in the IP addresses 313 in the load-distribution definition table 31 shown in FIG. 3. The determination of whether the SIP message is a request is performed by checking whether a head of the SIP start line includes a character string such as INVITE (establish a call), BYE (finish a call), or CANCEL (finish establishing processing in the middle of call setting). In the case of the operation (2) in FIG. 1, the IP address of the server-B 7 is set as the transmission source IP address, and, in the SIP start line 605, INVITE (establish a call) representing a request is set. Accordingly, the process proceeds to step S517.

In step S517, the CPU 301 sets a virtual IP address as the transmission source IP address of the packet. The virtual IP address is information that the relay apparatus 3 has as information related to the load-distribution definition table 31 in FIG. 3.

In step S513, the CPU 301 transmits the packet to the terminal-B 15 through the communication unit 307.

Finally, the process of the relay apparatus 3 when it performs the operation (3) in FIG. 1 is described below.

In step S501, the CPU 301 receives a packet generated and transmitted by the terminal-B 15 as the called party via the communication unit 307. In the case of the operation (3) in FIG. 1, the IP address of the terminal-B 15 is set as the source address, and a virtual IP address is set as the destination IP address. This is such that the destination address and source address of the packet received by the terminal-B 15 are switched. In addition, as the Call-ID header in the SIP header 607 in the packet, one that is identical to the Call-ID header in the SIP header 607 in the packet already received from the server-B 7 is set.

### 3.3. Example of Response Message

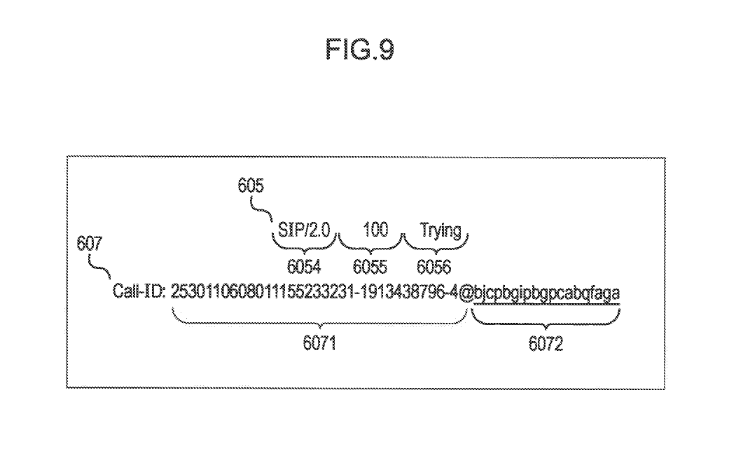

FIG. 9 shows examples of the SIP start line 605 and SIP header 607 in a packet used when the relay apparatus 3 performs the operation (3) in FIG. 1. In the case of the operation (3) in FIG. 1, in the SIP start line 605, a response message is set. Information elements of the SIP start line 605 include an SIP version 6054, a status code 6055, and a reason phrase 6056. The SIP version 6054 represents a version of an SIP in use. The status code 6055 represents a response type. The reason phrase 6056 is a character string representing a response reason. The SIP header 607, and pieces 6071 and 6072 of information in the SIP header 607 are similar to those shown in FIG. 8.

Referring back to FIG. 6, the process of the relay apparatus 3 when it performs the operation (3) in FIG. 1 is continuously described.

In step S503, the CPU 301 determines whether the received packet is addressed to a virtual IP. This determination is performed by checking whether the above IP address is identical to the above virtual IP address. In the case of the operation (3) in FIG. 1, a virtual IP address is set. Accordingly, the process proceeds to step S507.

In step S507, the CPU 301 verifies the format of the Call-ID. This verification is performed by determining whether the format of the Call-ID has been determined beforehand with a distributed server. This determination is performed by checking whether the number of characters of a portion 6072 succeeding at the mark of the Call-ID header is the sum of the IP address and the port number, and checking whether all character types are the converted characters as the converted information 333 in the server-information conversion table 33. In the case of the operation (3) in FIG. 1, the Call-ID header is identical to a Call-ID header in the SIP header 607 in the packet already received from the server-B 7. This Call-ID header has been determined beforehand with the distributed server. Accordingly, the process proceeds to step S519.

In step S519, the CPU 301 extracts an encrypted, server-information character-string portion from the Call-ID header. The encrypted server-information character-string portion is a portion 6072 succeeding at the mark in the Call-ID header. Accordingly, the portion 6072 succeeding at the mark is extracted.

In step S521, the CPU 301 decrypts the encrypted server-information character-string portion. The encrypted server-information character-string portion is the portion 6072 succeeding at the mark in the Call-ID header. In the decryption, the server-information conversion table 33 in FIG. 2 is used. In specific processing for the decryption, the converted information 333 is searched for characters representing the encrypted information character string, and the characters are replaced by corresponding characters as the source information 331.

In step S523, the CPU 301 determines whether the decryption has been successful. In this determination, by using the server-information conversion table 33, it is checked whether the portion 6072 succeeding at the mark in the Call-ID header has all been restored to an unconverted state. If the decryption has been successful, the process proceeds to step S525. If the decryption has not been successful, the process proceeds to step S509.

In step S525, the CPU 301 searches for a distributed server corresponding to the decrypted server information. This processing is performed by searching the decrypted-server-information character strings 353 in FIG. 5 for the decrypted server information, and extracting a corresponding distributed-server IP address 355.

In step S527, the CPU 301 determines whether the distributed server corresponding to the decrypted server information has been found. This determination is performed by checking whether the distributed-server IP address 355 corresponding to the decrypted server information is included in the distributed server correspondence table 35. If the distributed-server IP address 355 corresponding to the decrypted server information has been found, the process proceeds to step S529. If the distributed-server IP address 355 corresponding to the decrypted server information has not been found, the process proceeds to step S509.

In step S529, the CPU 301 rewrites the destination IP address of the packet into the found distributed-server IP address 355. This rewriting is performed by setting the distributed-server IP address 355 as the destination IP address of the IP header 601.

In step S513, the CPU 301 transmits the packet to the sever-B 7 as a distribution destination via the communication unit 307.

Although the present invention has been described on the basis of an embodiment, the present invention is not limited to the above-described embodiment.

What is claimed is:

1. A relay apparatus for transferring packets each including identification information specifying connection between a first apparatus and a second apparatus, a destination address, and a source address,
wherein:
from the first apparatus, the relay apparatus receives a first packet in which the identification information includes encryption information obtained by encrypting an address of the first apparatus, and which has an address of the second apparatus as the destination address, and the address of the first apparatus as the source address;
the relay apparatus transmits, to the second apparatus, a second packet in which the source address of the first packet is converted into an address of the relay apparatus;
from the second apparatus, the relay apparatus receives a third packet in which the destination address and source address of the second packet are switched; and
the relay apparatus transmits, to the first apparatus, a fourth packet in which the destination address is converted on the basis of the address of the first apparatus, which is obtained by decrypting encryption information included in the identification information of the third packet,

2. The relay apparatus according to claim 1, wherein the address of the first apparatus is information related to a number specifying a network-connected apparatus.

3. The relay apparatus according to claim 1, wherein the identification information is included in call control information, in each packet, for controlling audio communication.

4. A recording medium, readable by an information processing apparatus, containing a relay program for controlling a relay apparatus for transferring packets each including identification information specifying connection between a first apparatus and a second apparatus, a destination address, and a source address, the relay program allowing the relay apparatus to execute the steps of:
receiving, from the first apparatus, a first packet in which the identification information includes encryption information obtained by encrypting an address of the first apparatus, and which has an address of the second apparatus as the destination address, and the address of the first apparatus as the source address;
transmitting, to the second apparatus, a second packet in which the source address of the first packet is converted into an address of the relay apparatus;
receiving, from the second apparatus, a third packet in which the destination address and source address of the second packet are switched; and
transmitting, to the first apparatus, a fourth packet in which the destination address is converted on the basis of the address of the first apparatus, which is obtained by decrypting encryption information included in the identification information of the third packet.

5. A communication system comprising;
first and second apparatuses for transmitting and receiving packets each including identification information specifying connection between the first and second apparatuses, a destination address, and a source address; and
a relay apparatus connected to the first and second apparatuses,
wherein:
the first apparatus transmits, to the relay apparatus, a first packet in which the identification information includes encryption information obtained by encrypting an address of the first apparatus, and which has an address of the second apparatus as the destination address, and the address of the first apparatus as the source address;
the relay apparatus transmits, to the second apparatus, a second packet in which the source address of the first packet is converted into an address of the relay apparatus;
the second apparatus transmits, to the relay apparatus, a third packet in which the destination address and source address of the second packet are switched; and
the relay apparatus transmits, to the first apparatus, a fourth packet in which the destination address is converted on the basis of the address of the first apparatus, which is obtained by decrypting encryption information included in the identification information of the third packet.
